(19) United States
(12) Patent Application Publication
(10) Pub. No.: US 2024/0190283 A1
(43) Pub. Date: Jun. 13, 2024

(54) Computer-Implemented Method and Device for Triggering a High-Level Communication between an Electric Vehicle and a Charging

(71) Applicant: Vitesco Technologies GmbH, Regensburg (DE)

(72) Inventors: Balaji Thangam Aiyam Pillai, Tamilnadu (IN); Nisha Ramakrishnan, Mysore (IN); Adorian Berta, Timisoara (RO)

(73) Assignee: Vitesco Technologies GmbH, Regensburg (DE)

(21) Appl. No.: 18/444,935

(22) Filed: Feb. 19, 2024

Related U.S. Application Data
(63) Continuation of application No. PCT/EP2022/072900, filed on Aug. 17, 2022.

(30) Foreign Application Priority Data
Aug. 20, 2021 (DE) 10 2021 209 183.0
Aug. 20, 2021 (EP) 21465542.5
Aug. 30, 2021 (DE) 10 2021 209 487.2

(51) Int. Cl. B60L 53/66

(52) U.S. Cl. CPC B60L 53/66

(57) ABSTRACT

A computer-implemented method and a control device for triggering a high level communication between an electric vehicle and a charging station is provides. The electric vehicle includes a control unit with a first microcontroller and a second microcontroller. The method includes operating only the second microcontroller of the control unit for detecting a wake-up signal coming from a possible connection of the electric vehicle to a charging station and keeping the first microcontroller deactivated. The method also includes connecting the electric vehicle to the charging station, whereby at least one wake-up signal is sent to the control unit. Additionally, the method includes detecting the wake-up signal coming from the connection of the electric vehicle to the charging station with the second microcontroller. The method also includes activating the first microcontroller using the second microcontroller when the wake-up signal is detected.

### CROSS-REFERENCE TO RELATED APPLICATIONS

This application claims the benefit of PCT Application PCT/EP2022/072900, filed Aug. 17, 2022, which claims priority to German Application 10 2021 209 487.2, filed Aug. 30, 2021, German Application 10 2021 209 183.0, filed Aug. 20, 2021, and European Application 21465542.5, filed Aug. 20, 2021. The disclosures of the above applications are incorporated herein by reference.

### TECHNICAL FIELD

The disclosure relates to a computer-implemented method and to a control device for triggering a high-level communication between an electric vehicle and a charging station. The electric vehicle includes a control until for high-level communication between the charging station and the electric vehicle and for low-level communication between the charging station and the electric vehicles.

### BACKGROUND

Basic communication is used to detect a connection between a charging station and an electric vehicle and to perform basic signaling between the electric vehicle and the charging station. The high-level communication is used to control the charging process of the electric vehicle. The basic signaling and the high-level communication is also explained in ISO and IEC 61851 standard documents. The basic signaling between the electric vehicle and the charging station and the high-level communication require different resources. The high-level communication requires higher communication resources which may cause higher power/current consumption and the low-level communication involves basic signaling which requires lower power/current consumption.

Standard control units which control the communication between the electric vehicle and the charging station have one microcontroller which controls the high-level communication and the low-level communication between the charging station and the electric vehicle. Such control units with one microcontroller have a relatively high power/current consumption during the charging process of the electric vehicle and also during normal operation of the electric vehicle when no connection is established between the electric vehicle and the charging station. In the latter case, the control unit is always activated just in order to capture a signal coming from the charging station or a connection of the electric vehicle to the charging station in order to start the charging process of the electric vehicle. This lasting activation of the control unit of the electric vehicle even when no connection is established between the electric vehicle and the charging station leads to a very high power consumption and current consumption of the control unit only to detect a connection of the electric vehicle to the charging station.

### SUMMARY

The present disclosure provides a computer-implemented method and a control device which reduces energy consumption of the electric vehicle and/or increases the efficiency of the electric vehicle.

A computer-implemented method for triggering a high-level communication between an electric vehicle and a charging station is provided. The electric vehicle includes a control unit with a first microcontroller for high-level communication between a charging station and the electric vehicle and a second microcontroller for basic communication between the charging station and the electric vehicle. The control unit includes two microcontrollers, each microcontroller having its specific task. The first microcontroller has the task for high-level communication and the second microcontroller has the task for basic communication. The method for triggering the high-level communication between the electric vehicle and the charging station includes the following steps.

The method includes operating only the second microcontroller of the control unit for detecting a wake-up signal coming from a possible connection of the electric vehicle to the charging station and keeping the first microcontroller deactivated. In other words, during normal operation of the electric vehicle, for example during driving or standstill, the first microcontroller is deactivated and does not require any electric energy and only the second microcontroller is in operation for detection of a possible wake-up signal which comes from a possible connection of the electric vehicle to the charging station. The wake-up signal is a signal which is triggered from the connection of the electric vehicle to the charging station, or which comes directly from the charging station when the plug from the charging station is inserted into the electric vehicle for charging. During normal operation of the electric vehicle, only the second microcontroller requires energy for the detection of the wake-up signal.

The method also includes connecting the electric vehicle to the charging station, whereby at least one wake-up signal is sent to the control unit. In this step, the electric vehicle is connected to the charging station to recharge the electric vehicle. Due to the connection, the wake-up signal is sent to a control unit to start the communication between the control unit and the charging station to manage the charging process of the electric vehicle.

Additionally, the method includes detecting the wake-up signal coming from the connection of the electric vehicle to the charging station with the second microcontroller. In this step, the second microcontroller detects the wake-up signal which comes from the connection of the electric vehicle to the charging station directly itself or which comes from the charging station. The second microcontroller is designed to detect the wake-up signal which comes from the connection of the electric vehicle to the charging station.

The method also includes activating the first microcontroller for high-level communication between the electric vehicle and the charging station when the wake-up signal is detected. In other words, when the second microcontroller detects the wake-up signal which comes from the connection of the electric vehicle to the charging station, then the first microcontroller is activated, for example using the second microcontroller, for the required high-level communication between the electric vehicle to the charging station to initiate the recharging process of the electric vehicle.

Implementations of the disclosure may include one or more of the following optional features. In some implementations, the tasks of high-level communication and the low-level communication are separated between the first microcontroller and the second microcontroller of the control unit for the charging process. The first microcontroller is responsible for the high-level communication which requires a high-power consumption, and the second microcontroller is responsible for the basic communication between the charging station and the electric vehicle which does not require the high energy consumption. Therefore, it is possible to keep the first microcontroller deactivated for most of the operating time of the electric vehicle besides the actually charging process of the electric vehicle. This is achievable only using the second microcontroller which monitors if a wake-up signal coming from the connection of the electric vehicle to the charging station or which comes directly from the charging station. The overall power consumption of the control unit is reduced over the lifetime of the electric vehicle which increases the range of the electric vehicle and the overall efficiency of the electric vehicle. In some examples, it is conceivable that the microcontroller receives the wake-up signal from another control unit which predicts a future charging process coming, for example, from the navigation system which plans the recharging processes.

In some implementations, the second microcontroller operates using a polling sequence for the detection of the wake-up signal coming from the connection of the electric vehicle to the charging station. Polling is the process where the control unit waits for the external device to check for its readiness or state. The polling sequence may be used to detect the wake-up signal. With the polling sequence also the second microcontroller is not always activated. It is only activated when the polling sequence activates the second microcontroller. As such, with the use of the polling sequence for the detection of the wake-up signal coming from the connection of the electric vehicle, the power consumption of the second microcontroller can be further reduced which increases the overall efficiency of the control unit and therefore the overall efficiency of the electric vehicle. The polling sequence for the detection of the wake-up signal helps achieve the desired efficiency of the control unit.

In some examples, the polling sequence and a length of the wake-up signal are adjusted to each other so that each wake-up signal is detected by the second microcontroller. The wake-up signal has a predefined length which is for example 100 milliseconds or 200 milliseconds. The polling sequence includes highs and lows and the wake-up signal is only detected by the second microcontroller when a high of the polling sequence and the wake-up signal occur at the same time. Therefore, it is necessary that a polling sequence is shorter than the length of the wake-up signal. In other words, the time between the highs and the lows of the polling sequence must be smaller than the overall length of the wake-up signal. In this case, at least one high of the polling sequence occurs which detects the presence of the wake-up signal coming from the connection between the electric vehicle and the charging station. This results in a simple and reliable way to detect each wake-up signal coming from the connection between the electric vehicle and the charging station. Further, the adjustment of the polling sequence and the length of the wake-up signal creates a reliable and efficient method to detect each and every wake-up signal in combination with a low power consumption of the second microcontroller.

In some examples, the polling sequence includes a fast polling sequence and/or a slow polling sequence. In this case, the polling sequence may be a fast polling sequence, a slow polling sequence, or a combination of a fast polling sequence and a slow polling sequence. The difference between the fast polling sequence and the slow polling sequence is that the fast polling sequence has a higher frequency than the slow polling sequence. For example, the fast polling sequence may have a five times higher frequency than the slow polling sequence. In some examples, the fast polling sequence is used to detect a fast wakeup signals like button, flap, or switches and the slow polling sequence is used to detect a slow wakeup signal/source like ADC inputs and control pilot signals from the charging station.

In some examples, each polling sequence is implemented using a PWM signal on the second microcontroller. The PWM signal is a pulse width modulation signal with constant period time. The period of the slow polling sequence is for example five times longer than the period of the fast polling sequence. The PWM signal may be easy to implement on the second microcontroller and to achieve the desired advantage for the detection of the wake-up signal. This results in an easy and simple way to implement the required detection functionality on the second microcontroller for a reliable detection of the wake-up signal coming from the connection between the electric vehicle and the charging station.

In some implementations, the fast polling sequence is designed to capture a status of digital input and the slow polling sequence is designed to monitor a PWM signal from the charging station and/or ADC input signal from the charging station. The digital inputs refer to switches and flaps which constitute the fast wakeup source monitored by fast polling sequence. The control pilot signal (PWM signal) and ADC are used for basic signaling and are monitored by the slow polling sequence. The communication standard only mentions control pilot and ADC, the fast polling sources are, for example, additional requirements which is to ensure the charger plug connection to the charging station is successful. This can be used based on requirements, since the implementation is generic so that all possible wakeup sources can be detected. In some examples, the control pilot signal determines the connection status, voltage available for charging and charging status in case of AC charging in case of DC charging it produces a pulse of constant duty which indicates that the charging process must switch to high level communication. The specified design is implemented in such a way that different types of connectors with different fast wakeup signals and slow wakeup signals can be recognized by the same software thus, can be reused for multiple vehicles with minimum update.

In some implementations, the first microcontroller is activated via the second microcontroller by activating a power supply of the first microcontroller where the first microcontroller is woken up for the high-level communication between the electrical vehicle and the charging station. In this case, the first microcontroller or the control unit includes a power supply for the first microcontroller. The activation of this power supply of the first microcontroller activates the first microcontroller for the desired high-level communication between the electric vehicle and the charging station. Additionally, the second microcontroller just activates the power supply of the first microcontroller for the activation of the first microcontroller. This results in a simple and reliable way to activate the first microcontroller after the wake-up signal is detected from the connection between the electric vehicle and the charging station.

In some implementations, the second microcontroller switches to a transmit mode after detecting the wake-up signal, where in the transmit mode, data from the connection of the electric vehicle to the charging station and/or high level communication data from and to the charging station is transmitted via the second microcontroller to and from the first microcontroller. In the transmit mode, the second microcontroller just transfers the data coming from the charging station to the first microcontroller and the data coming from the first microcontroller to the charging station. This reduces the required wiring and reduces the overall complexity of the control unit.

In some examples, the second microcontroller records the wakeup signals during fast and slow polling. If data consistent with wakeup event, the wakeup of the first microcontroller is done. After the first microcontroller was woken up, by request, the wakeup records from second microcontroller are sent to first microcontroller. In this case, data is collected within the second microcontroller and sent to the first microcontroller after the activation of the first microcontroller.

In some implementations, the communication between the first microcontroller and the second microcontroller is a synchronous to asynchronous communication from the first microcontroller to the second microcontroller. The communication is in request response format. The request is sent from the first microcontroller and the response is sent from the second microcontroller. A clock reference for the entire duration of the communication is given by the first microcontroller. The software implemented supports two types of format, type one format includes 16 bytes format (16 clock pulses) and type two format includes 24 bytes format (24 clock pulses). The use of the particular type format depends on the functionality requested from the second microcontroller. The type two format is mainly used for a response which requires more than 8 bytes response. Those format types (type 1 and type 2) use 8 bytes for request and the remaining 8 or 16 bytes for response, this reduces the communication load on the second microcontroller. The idle time between request and response is greater than the maximum time required by the second microcontroller for execution of the request and collecting the data for a response. This is to ensure the correct response is ready before the second sequence of the clock pulse starts. The second microcontroller is in receive mode by default during start up and switches to transmit mode only when a response is to be sent to the request from the first microcontroller. Thus, with the above design synchronous to a synchronous communication between the first microcontroller and the second microcontroller is managed in an advantageous manner.

The present disclosure makes it possible to detect a connection between the electric vehicle and the charging station and to trigger the high-level communication between the control unit and the charging station between all different types of connectors, like Type 1 (IEC 62196 Type 1), Type 2 (IEC 62196 Type 2), CHAdeMO, Chaoji, China AC and China DC connectors between the electric vehicle and the charging station.

In some implementations, the wake-up signal is coming from the connection between the electric vehicle and the charging station as a PWM signal, also known as control pilot from the charging station. The control pilot may be used in both AC and DC charging. In AC charging it is used to determine the state of the station as the state defined in the standard IEC 61851-1. In DC charging, it may also be used to force high-level communication.

The overall design of the control unit in combination with the charging station and the software design ensures a very low energy/current consumption of the control unit during the overall operation of the electric vehicle including during the charging process and further it ensures an individual control of all peripherals.

Another aspect of the disclosure provides a control device for triggering a high-level communication between an electric vehicle and a charging station. The control device may be part of the electric vehicle where the electric vehicle includes a control unit with a first microcontroller for high-level communication between the charging station and the electric vehicle and a second microcontroller for basic communication between the charging station and the electric vehicle. The control device is designed to execute a computer-implemented method as described above. The control device may be the control unit or the second microcontroller itself. It is also conceivable that the control device is part of a control device of the electric vehicle or of the power train of the electric vehicle. It is also conceivable that the control device is implemented in a server architecture of the electric vehicle.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a schematic view of an exemplary setup of a control unit of an electric vehicle.

FIG. 2 shows a schematic view of an exemplary communication set up between the first microcontroller and the second microcontroller.

FIG. 3 shows a schematic view of an exemplary fast polling sequence and an exemplary slow polling sequence.

Like reference symbols in the various drawings indicate like elements.

### DETAILED DESCRIPTION

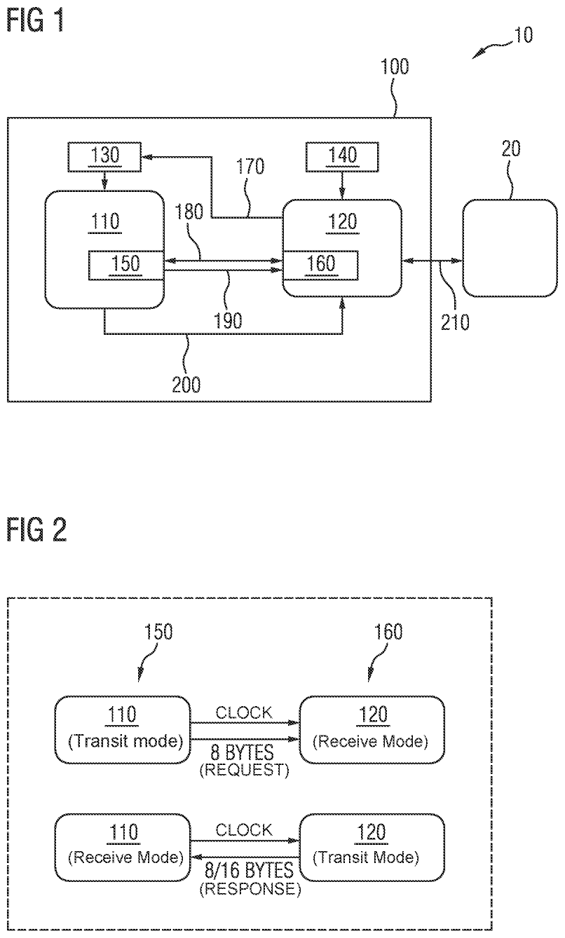

FIG. 1 shows a control unit 100 in an electric vehicle 10. FIG. 1 also includes a charging station 20 for recharging the electric vehicle 10. The control unit 100 includes a first microcontroller 110 and a second microcontroller 120. The first microcontroller 110 is designed to execute high-level communication between the charging station 20 and the electric vehicle 10. The second microcontroller 120 is designed to execute basic communication between the charging station 20 and the electric vehicle 10. The control unit 100 further includes a first power supply 130 and a second power supply 140. The first power supply 130 is designed to provide electric energy for the first microcontroller 110 and the second power supply 140 is designed to provide electric energy for the second microcontroller 120. The first microcontroller 110 uses a synchronous communication 150 to an asynchronous communication 160 to the second microcontroller 120. This synchronous communication 150 to asynchronous communication 160 is also shown in FIG. 1.

For the synchronous communication 150 to asynchronous communication 160 clock pulse 190 is provided from the first microcontroller 110 to the second microcontroller 120 and data signals 180 are transmitted between the first microcontroller 110 and the second microcontroller 120. FIG. 1 further shows a wake-up line 170 which goes from the second microcontroller 120 to the first power supply 130. FIG. 1 also shows a reset line 200 from the first microcontroller 110 to the second microcontroller 120 which is designed to reset the second microcontroller 120. Additionally, FIG. 1 shows an analog/digital line 210 between the second microcontroller 120 and the charging station 20. During normal operation of the electric vehicle 10 and the control unit 100, the first microcontroller 110 is deactivated and therefore in stand-by-mode. In this case, the first power supply 130 does not supply electric power to the first microcontroller 110. During this time, only the second microcontroller 120 is activated and the second power supply 140 provides electric energy to the second microcontroller 120. When the electric vehicle 10 is connected to the charging station 20, a wake-up signal is sent to the second microcontroller 120 through the analog/digital line 210. This wake-up signal is detected by the second microcontroller 120. The second microcontroller 120 may use a polling sequence which may include a fast polling sequence and a slow polling sequence for the detection of the wake-up signal coming from the connection between the electric vehicle 10 and the charging station 20. When the wake-up signal is detected by the second microcontroller 120, the power of the first power supply 130 is activated via the wake-up line 170 by the second microcontroller 120. The activation of the first power supply 130 activates the first microcontroller 110 and the high-level communication between the first microcontroller 110 and the charging station 20 may be activated or may start. The second microcontroller 120 may store the status of all wakeup sources during polling and when the status of wakeup sources is requested by first microcontroller 110 through synchronous communication 150 to asynchronous communication 160 based on the information received, the first microcontroller 110 may activate high level communication.

FIG. 2 shows a communication diagram 300 between the communication of the first microcontroller 110 and the second microcontroller 120. The first microcontroller 110 uses synchronous communication 150 and the second microcontroller 120 uses asynchronous communication 160. The communication diagram 300 shows a request from the first microcontroller 110 to the second microcontroller 120 and a response from the second microcontroller 120 to the first microcontroller 110. During the request, the first microcontroller 110 is in the transmit mode and the second microcontroller 120 is in the receive mode. The first microcontroller 110 sends clock pulse 190 to the second microcontroller 120 and the request using 8 bytes to the second microcontroller 120 through the data lines 180. During the request, the second microcontroller is in the receiving mode. In the response, still the first microcontroller 110 sends the clock pulse 190 to the second microcontroller 120 but the second microcontroller 120 sends the response to the first microcontroller 110 using 8 or 16 bytes depending on type 1 communication or type 2 communication through the data lines 180. During the response, the second microcontroller 120 is in a transmit mode and the first microcontroller 110 is in the receive mode.

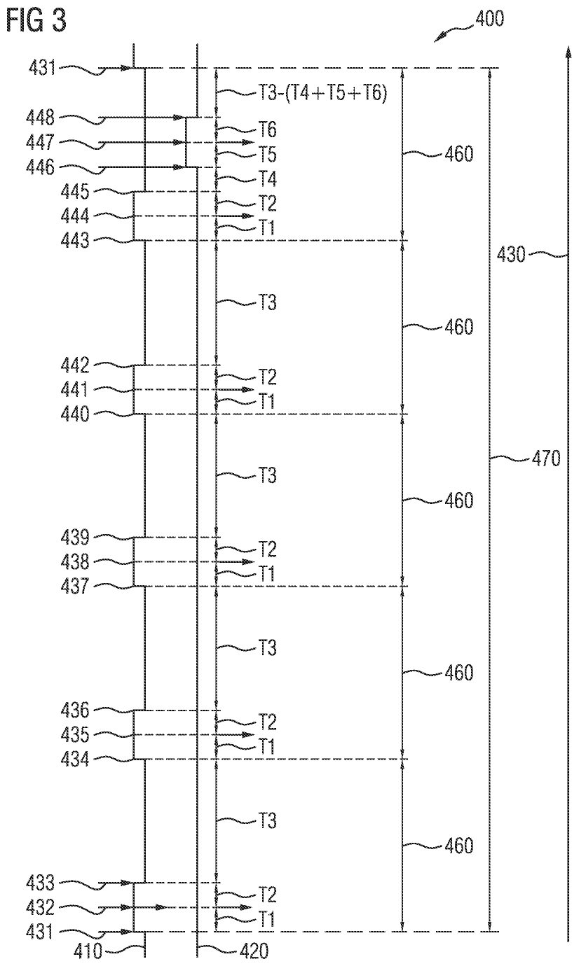

FIG. 3 shows a sequence diagram 400 with a fast polling sequence 410 and a slow polling sequence 420. The polling sequences 410, 420 are used and implemented within the second microcontroller 120 to detect the wake-up signal coming from the charging station 20 or coming from a connection of the electric vehicle 10 to the charging station 20. The sequence diagram 400 further shows a time axis 430. The polling sequences which is used for detection of the wake-up signal may include the fast polling sequence 410 and the slow polling sequence 420. The fast polling sequence 410 and the slow polling sequence 420 are both PWM signals which are implemented in the second microcontroller 120. The full period of the first polling sequence 410, the small cycle 460 consists of the first time span T1, the second time span T2 and the third time span T3. Those three time spans make up the small cycle 460. The pulse of the first polling sequence 410 is defined by the first time span T1 plus the second time span T2. The period of the slow polling sequence 420 includes four small cycles 460 and one first time span T1, one second time span T2, one fourth time span T4, one fifth time span T5, and one second time span T6 and in addition, one third time span T3 minus a combination of the fourth time spanT4, the fifth time span T5 and the sixth time span T6. Five small cycles 460 make up a full command cycle 470 which includes five pulses of the fast polling sequence 410 and one pulse of the slow polling sequence 420. During the time period T3, the control unit 100 is not able to detect the wake-up signal, only during the active time period T1 and T2 which defines the pulse of the PWM signal of the fast polling sequence 410. In order to detect each wake-up signal, the wake-up signal length must be longer than the time span T3. For example, if the wake-up signal has a length of 200 ms, the time span T3 has, for example, a length of 120 ms. In this case, each and every wake-up signal passes a least one pulse defined by the time span T1 and T2 of the fast polling sequence 410 which allows the second microcontroller 120 to detect the wake-up signal and therefore to trigger the high-level communication. According to this example, the fast polling sequence 410 reads digital signals and the slow polling sequence 420 reads analog signals coming from the charging station 20. The fast polling sequence 410 is able to capture all fast wake up sources like switches flap and button and the slow polling sequence 420 is used for monitoring the control pilot signal and ADC inputs used for basic signaling thus having combination of both polling sequences 410, 420 allows to detect all wakeup sources for the electric vehicle 10 for charging and also low level basic signaling can be accomplished in a relatively simple manner.

In some implementations, the pulses of the fast polling sequence 410 do not overlap with the pulse of the fast polling sequence 420, this is also shown in FIG. 3. In some examples, the slow polling sequence 420 monitors all possible ADC sources for a particular type of charger along with the control pilot PWM signal. The timing parameters for the fast polling sequence 410 and the slow polling sequence 420 are configurable depending on the requirements.

The first node 431, the fourth node 434, the seventh node 437, the tenth node 440, and the thirteenth node 443, generate the switch on and the third node 433, the sixth node 436, the nineth node 439, the twelfth node 442, and the fifteenth node 445 will generate the switch off of the fast polling sequence 410 with specific delays. The second node 432, the fifth node 435, the eighth node 438, the eleventh node 441, and the fourteenth node 444 will read the digital inputs during the fast polling sequence high times. The sixteenth node 446 and the eighteenth node 448 generate the pulse of the slow polling sequence 420 and the seventeenth node 447 will read the analogue signals with required timings.

Analog and control pilot signal will be, according to this example, captured during the pulse of the slow pulling sequence 420 (seventeenth node 447).

The time between the eighteenth node 448 and the first node 431 should be (T3−(T4+T5+T6)) to ensure no overlapping of the pulses of the fast polling sequence 410 and the pulse of the slow polling sequence.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method for triggering a high level communication between an electric vehicle and a charging station, wherein the electric vehicle comprises a control unit with a first microcontroller for high level communication between the charging station and the electric vehicle and a second microcontroller for basic communication between the charging station and the electric vehicle, the computer-implemented method comprising:
operating only the second microcontroller of the control unit for detecting a wake-up signal coming from a possible connection of the electric vehicle to a charging station and keeping the first microcontroller deactivated;
in consequence of connecting the electric vehicle to the charging station and the control unit, receiving at least one wake-up signal detecting the wake-up signal coming from the connection of the electric vehicle to the charging station with the second microcontroller; and
activating the first microcontroller for high level communication between the electric vehicle and the charging station when the wake-up signal is detected.

2. A computer-implemented method of claim 1, wherein the second microcontroller operates using a polling sequence for the detection of the wake-up signal coming from the connection of the electric vehicle to the charging station.

3. A computer-implemented method of claim 2, wherein the polling sequence and a length of the wake-up signal are adjusted to each other in order that each wake-up signal is detected by the second microcontroller.

4. A computer-implemented method of claim 2, wherein the polling sequence comprises a fast polling sequence and/or a slow polling sequence is implemented using one PWM signals on the second microcontroller.

6. A computer-implemented method of claim 4, wherein the fast polling sequence is designed to capture a status of digital input and wherein the slow polling sequence is designed to monitor a PWM-signal from the charging station and/or ADC input signals from the charging station.

7. A computer-implemented method of claim 1, wherein the first microcontroller is activated via the second microcontroller by activating a power supply of the first microcontroller whereby the first microcontroller is woken up for the high level communication between the electric vehicle and the charging station.

8. A computer-implemented method of claim 1, wherein the second microcontroller switches to a transmit mode after detecting the wake-up signal, wherein in the transmit mode data from the connection of the electric vehicle to the charging station and/or high level communication data from and to the charging station is transmitted via the second microcontroller to and from the first microcontroller.

9. A computer-implemented method of claim 1, wherein the communication between the first microcontroller and the second microcontroller is a synchronous to asynchronous communication from the first microcontroller to the second microcontroller.

10. A control device for triggering a high level communication between an electric vehicle and a charging station, the control device comprising:
a control unit supported by the electric vehicle, the control unit includes:
a first microcontroller for high level communication between the charging station and the electric vehicle, and
a second microcontroller for basic communication between the charging station and the electric vehicle, the control unit executes a method comprising:
operating only the second microcontroller for detecting a wake-up signal coming from a possible connection of the electric vehicle to a charging station and keeping the first microcontroller deactivated;
in response to connecting the electric vehicle to the charging station and the control unit, receiving at least one wake-up signal and detecting the wake-up signal coming from the connection of the electric vehicle to the charging station with the second microcontroller; and
activating the first microcontroller for high level communication between the electric vehicle and the charging station when the wake-up signal is detected.

11. The control device of claim 10, wherein the second microcontroller operates using a polling sequence for the detection of the wake-up signal coming from the connection of the electric vehicle to the charging station.

12. The control device of claim 11, wherein the polling sequence and a length of the wake-up signal are adjusted to each other in order that each wake-up signal is detected by the second microcontroller.

13. The control device of claim 11, wherein the polling sequence comprises a fast polling sequence and/or a slow polling sequence is designed to capture a status of digital input and wherein the slow polling sequence is designed to monitor a PWM-signal

15. The control device of claim 11, wherein each polling sequence is implemented using one PWM signals on the second microcontroller. from the charging station and/or ADC input signals from the charging station.

16. The control device of claim 10, wherein the first microcontroller is activated via the second microcontroller by activating a power supply of the first microcontroller whereby the first microcontroller is woken up for the high level communication between the electric vehicle and the charging station.

17. The control device of claim 10, wherein the second microcontroller switches to a transmit mode after detecting the wake-up signal, wherein in the transmit mode data from the connection of the electric vehicle to the charging station and/or high level communication data from and to the charging station is transmitted via the second microcontroller to and from the first microcontroller.

18. The control device of claim 10, wherein the communication between the first microcontroller and the second microcontroller is a synchronous to asynchronous communication from the first microcontroller to the second microcontroller.
